(19) United States
(12) Patent Application Publication
(10) Pub. No.: US 2003/0193272 A1
(43) Pub. Date: Oct. 16, 2003

(54) Mail handling safety system

(76) Inventor: John I. Bryan, Scooba, MS (US)

Correspondence Address: Michael S. Neustel, Suite No.4, 2534 South University Drive, Fargo, ND, 58103, US

(21) Appl. No.: 10/047,740

(22) Filed: Nov. 9, 2001

(51) Int. Cl. A61G 11/00

(52) U.S. Cl. 312/1

(57) ABSTRACT

A mail handling safety system for allowing an individual to safely open mail and packages. The mail handling safety system includes a container having at least one side wall, an upper portion sealed upon the side wall and a lower opening within the container, a pair of apertures extending into the side wall sufficient in size to receive the arms of an individual, a pair of guides on opposing sides of the apertures, and a door member slidably positioned within the guides for selectively closing the apertures if a contaminated parcel is positioned within the container. The container is comprised of a transparent or semi-transparent material for allowing the user to view the interior of the container. The user places the parcels of mail upon an upper surface of a flat structure and then inserts their hands through the apertures. The user then opens the parcels of mail and if a parcel contains a suspected biological or chemical contaminant, the user then removes their arms and closes the door members about the apertures until the appropriate personnel may arrive to inspect the parcel.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to mail handling devices and more specifically it relates to a mail handling safety system for allowing an individual to safely open parcels of mail and packages without contaminating a surrounding environment.

2. Description of the Prior Art

Mailboxes have been in use for years. A conventional mailbox typically is comprised of an elongate housing structure with a door pivotally attached to a front portion thereof for selectively closing upon a front opening. An individual retrieves the mail from within the mailbox by opening the door and then grasping the mail. The individual then typically enters a building structure or similar location to open the mail and packages. If a parcel is contaminated with biological or chemical contaminants (e.g. anthrax spores), when the individual opens the parcel the contaminants within are unfortunately able to freely disperse into the air. Anthrax spores (bacillus anthracis) are able to float within the air wherein they are able to infect an individual within their respiratory system or by coming in contact with their skin. The most deadly form of infection from anthrax is from inhalation.

While these devices may be suitable for the particular purpose to which they address, they are not as suitable for allowing an individual to safely open mail and packages. There is no conventional system for protecting individuals from being exposed to biological and chemical contaminants.

In these respects, the mail handling safety system according to the present invention substantially departs from the conventional concepts and designs of the prior art, and in so doing provides an apparatus primarily developed for the purpose of allowing an individual to safely open mail and packages.

### SUMMARY OF THE INVENTION

In view of the foregoing disadvantages inherent in the known types of mail opening devices now present in the prior art, the present invention provides a new mail handling safety system construction wherein the same can be utilized for allowing an individual to safely open mail and packages.

The general purpose of the present invention, which will be described subsequently in greater detail, is to provide a new mail handling safety system that has many of the advantages of the mail related devices mentioned heretofore and many novel features that result in a new mail handling safety system which is not anticipated, rendered obvious, suggested, or even implied by any of the prior art mail devices, either alone or in any combination thereof.

To attain this, the present invention generally comprises at least one side wall, an upper portion sealed upon the side wall and a lower opening within the container, a pair of apertures extending into the side wall sufficient in size to receive the arms of an individual, a pair of guides on opposing sides of the apertures, and a door member slidably positioned within the guides for selectively closing the apertures if a contaminated parcel is positioned within the container. The user places the parcels of mail upon an upper surface of a flat structure and then inserts their hands through the apertures. The user then opens the parcels of mail and if a parcel contains a suspected biological or chemical contaminant, the user then removes their arms and closes the door members about the apertures until the appropriate personnel may arrive to inspect the parcel.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a mail handling safety system that will overcome the shortcomings of the prior art devices.

A second object is to provide a mail handling safety system for allowing an individual to safely open mail and packages.

Another object is to provide a mail handling safety system that reduces the likelihood of exposure to potentially harmful chemicals and biological contaminants.

An additional object is to provide a mail handling safety system that allows an individual to seal contaminated mail until appropriate personnel are able to reach the potential contamination site.

A further object is to provide a mail handling safety system that is easy to utilize.

Another object is to provide a mail handling safety system that fits about various shapes and sizes of mail and packages.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in an exploded position above mail.

FIG. 2 is an upper perspective view of the present invention surrounding mail upon a surface.

FIG. 3 is a front view of the present invention showing the arm holes in an open position.

FIG. 4 is a front view of the present invention showing the arm holes in the closed position.

FIG. 5 is a top view of the present invention.

FIG. 6 is a cross sectional view taken along line 6-6 of FIG. 2.

FIG. 7 is a magnified view of the sliding door that selectively closes about the arm hole.

### DESCRIPTION OF THE PREFERRED EMBODIMENT

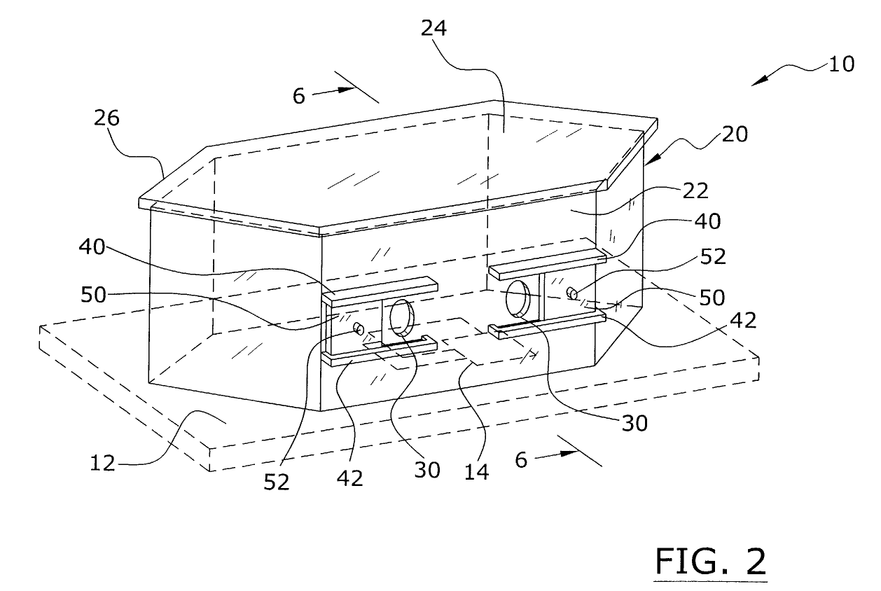

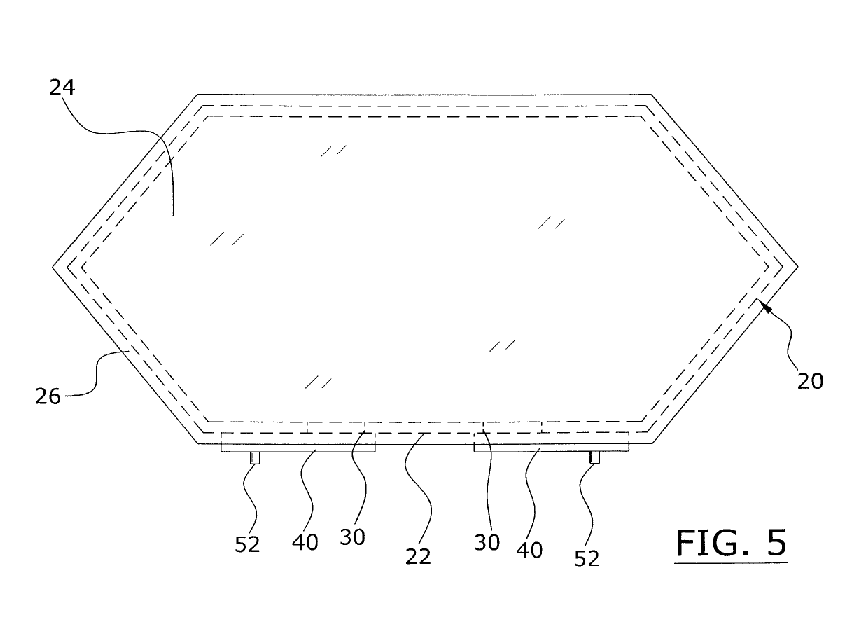

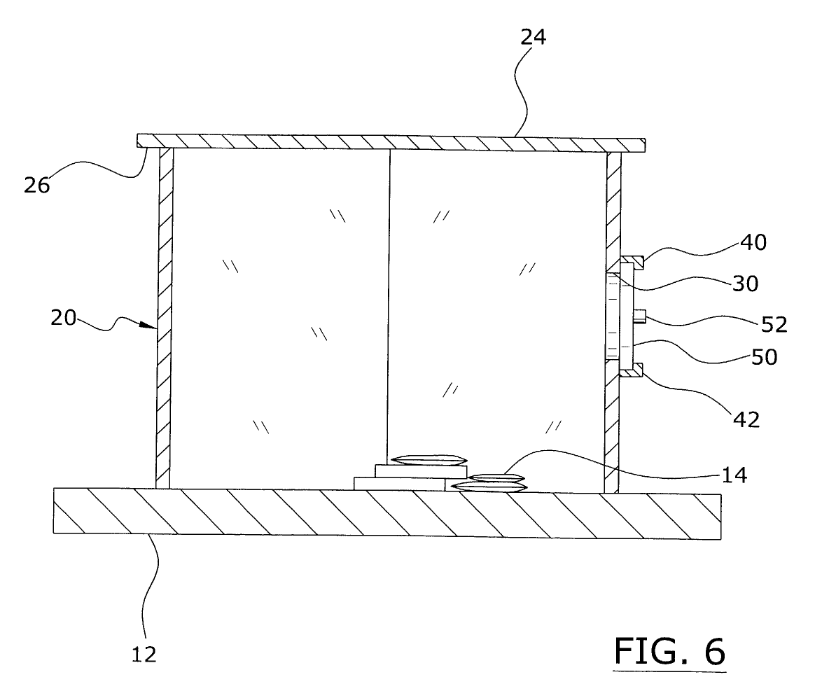

Turning now descriptively to the drawings, in which similar reference characters denote similar elements throughout the several views, FIGS. 1 through 7 illustrate a mail handling safety system 10, which comprises at least one side wall 22, an upper portion 24 sealed upon the side wall 22 and a lower opening within the container 20, a pair of apertures 30 extending into the side wall 22 sufficient in size to receive the arms of an individual, a pair of guides on opposing sides of the apertures 30, and a door member 50 slidably positioned within the guides for selectively closing the apertures 30 if a contaminated parcel is positioned within the container 20. The user places the parcels of mail 14 upon an upper surface of a flat structure 12 and then inserts their hands through the apertures 30. The user then opens the parcels of mail 14 and if a parcel contains a suspected biological or chemical contaminant, the user then removes their arms and closes the door member 50s about the apertures 30 until the appropriate personnel may arrive to inspect the parcel.

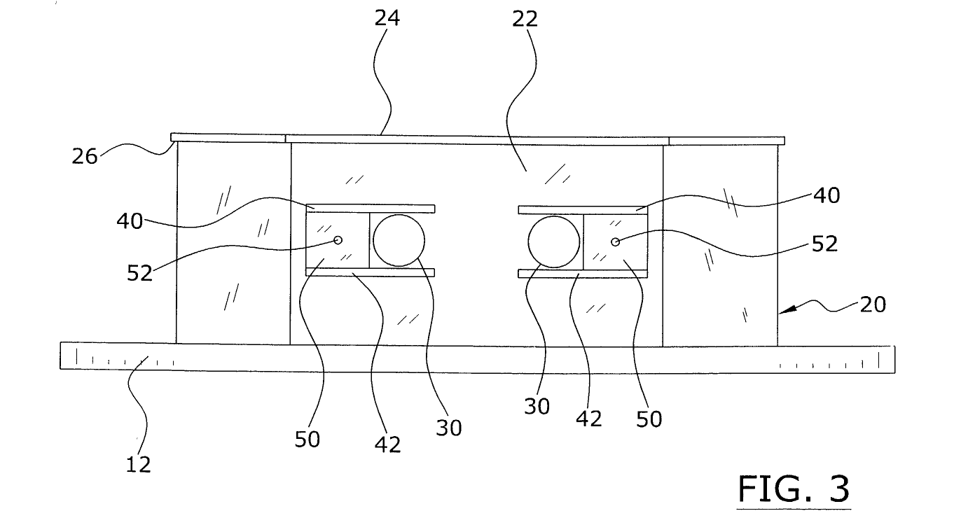

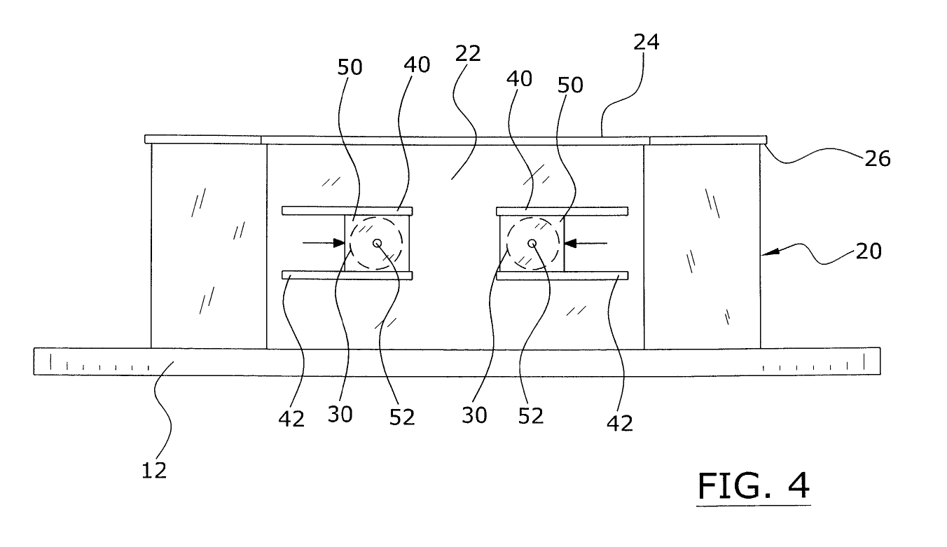

As shown in FIGS. 1 through 4 of the drawings, the container 20 is a generally broad structure having at least one side wall 22 and a lower opening defined by the side wall 22. The container 20 may have various shapes and sizes that are capable of covering a specific volume of mail 14. The container 20 may have a circular, oval, square, rectangular, or polygonal shape. The side wall 22 may have one or more sections within thereby defining the side wall 22. The side wall 22 is comprised of a substantially non-permeable structure. The lower opening within the container 20 is preferably defined by the side wall 22, however the lower opening may be formed utilizing additional structure. In addition, the lower edge of the container 20 is preferably sufficiently flat so as to form a significant seal when positioned upon a flat upper surface of a flat structure 12 as shown in FIGS. 3 and 4 of the drawings. A sealing strip may also be attached to the lower edge of the container 20 to further enhance the sealing of the interior of the container 20.

The container 20 further includes an upper portion 24 that is attached to the upper end of the side wall 22 thereby sealing the upper section of the container 20. The upper portion 24 is preferably comprised of a generally flat structure 12 as shown in FIGS. 1 through 4 of the drawings. The upper portion 24 further includes a flanged portion 26 that extends outwardly from the side wall 22 as shown in FIGS. 1 through 4 of the drawings. The flanged portion 26 may be utilized by the individual to grasp and manipulate the container 20. An additional engaging structure may be attached to the container 20 for facilitating manipulation of the container 20 during usage thereof.

The container 20, including the side wall 22 and the upper portion 24, is preferably comprised of a transparent or semi-transparent material for allowing viewing of the mail 14 while contained within the container 20. The container 20 is preferably comprised of a transparent plastic material, however, various other types of transparent and semi-transparent materials may be utilized in the construction of the container 20. It can be appreciated that the upper portion 24 may be comprised of a transparent material while the side wall 22 is comprised of a non-transparent material or vice-versa.

As shown in FIGS. 1 through 3 of the drawings, a pair of apertures 30 extend into the side wall 22 of the container 20. The apertures 30 have a size sufficient for allowing the hands and arms of an individual to enter the interior portion of the container 20. The apertures 30 may have various shapes such as but not limited to circular, square, rectangular and polygonal. The apertures 30 are preferably positioned near one another on a similar elevation to correspond with a user's natural body position. It can be appreciated that more than two apertures 30 may extend into the side wall 22 of the container 20. In addition, one or more apertures 30 may also extend into the upper portion 24 of the container 20 for providing access to the interior portion of the container 20.

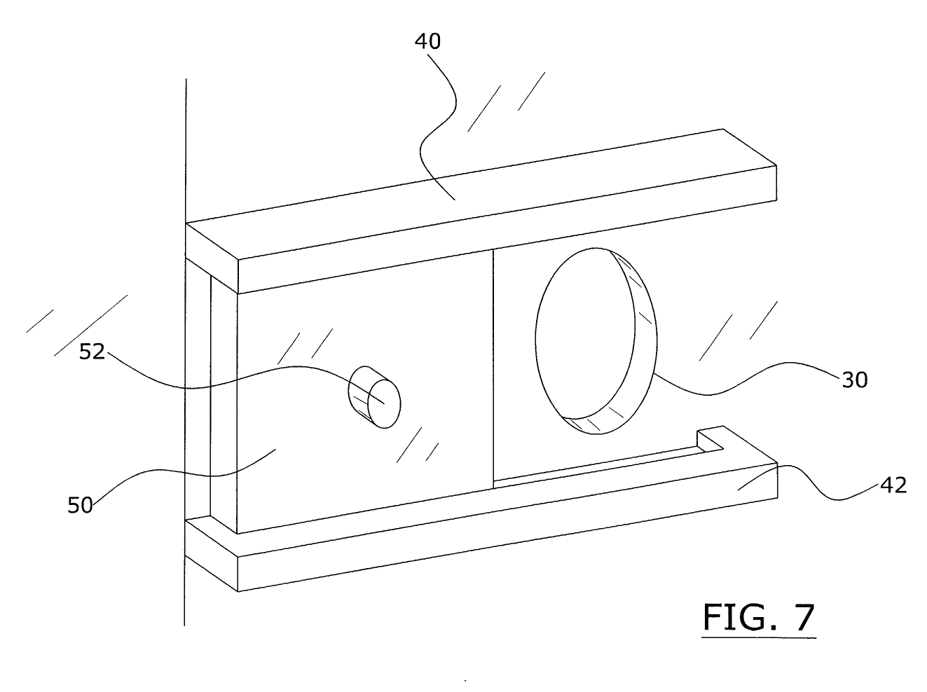

As further shown in FIGS. 1 through 4 of the drawings, an upper guide 40 is attached above each of the apertures 30 in a substantially horizontal manner. A lower guide 42 is attached below each of the apertures 30 in opposition to the upper guide 40 in a substantially horizontal manner. Each of the guides 40, 42 has an inner opposing slot that slidably receives a door member 50 as shown in FIG. 7 of the drawings. The door member 50 is preferably a rectangular structure sufficient in size to enclose the entire aperture 30. A handle 52 or other engaging structure is preferably attached to each door member 50 for facilitating manipulation of the door member 50 into an open or closed position with respect to a corresponding aperture 30. It can be appreciated that the guides 40, 42 and the corresponding door member 50 may be orientated in a vertical manner though not illustrated in the figures. The door member 50 is preferably comprised of a material similar to the container 20 to allow for viewing of the interior of the container 20.

In use, the user retrieves their parcels of mail 14 from a mailbox or similar location. The user then positions the parcels of mail 14 upon a flat upper surface of a flat structure 12 as shown in FIG. 1 of the drawings. The user then grasps the container 20 and lifts the container 20 directly above the mail 14 upon the flat structure 12 as shown in FIG. 1 of the drawings. The user then lowers the container 20 upon the mail 14 so that the mail 14 is completely enclosed by the side wall 22 of the container 20 as shown in FIG. 1 of the drawings. The user then inserts their hands into the apertures 30 and begins to open the mail 14 within the container 20. If a parcel of mail 14 is suspected of containing a contaminant, the user immediately removes their hands from the container 20 then slides each door member 50 to close all of the apertures 30 thereby sealing the mail 14 within the container 20. The user is then able to contact the appropriate authorities for further investigation without fear of contaminating the entire building structure.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mail handling safety system for being positioned about parcels of mail to be opened, comprising:
a container having a side wall, an upper portion enclosing an upper end of said side wall, and a lower opening, wherein said container is comprised of a lucid material; and
a plurality of apertures extending into said container, wherein each of said apertures are formed for receiving the hands of a user.

2. The mail handling safety system of claim 1, including a guide structure and a door member slidably positioned within said guide structure adjacent each of said apertures, wherein said door member is capable of enclosing each of said apertures.

3. The mail handling safety system of claim 2, including a handle attached to said door member.

4. The mail handling safety system of claim 3, wherein said guide structure is comprised of a lower guide positioned below said apertures and an upper guide positioned above said apertures, wherein said lower guide and upper guide include an inner opposing slot that slidably receives said door member. comprised of a lucid material and includes a plurality of apertures extending into said container, wherein each of said apertures are formed for receiving the hands of a user;
(c) positioning said container above said parcels of mail so that said lower opening is positioned in opposition to said parcels of mail;
(d) lowering said container upon said parcels of mail until a lower edge surrounding said lower opening of said container sealably engages said flat surface;
(e) inserting hands into said apertures;
(f) opening desired units of said parcels of mail;
(g) removing hands from said apertures if a parcel of mail is suspected of containing a contaminant; and
(h) closing said door member upon said apertures.
